(19) United States
(12) Patent Application Publication
(10) Pub. No.: US 2025/0155077 A1
(43) Pub. Date: May 15, 2025

(54) Removable Bracket

(71) Applicant: Textron Aviation Inc., Wichita, KS (US)

(72) Inventors: Gavin Thomas Smith, Wichita, KS (US); Alexander Husni, Towanda, KS (US); Mark Kendall Mallonee, Wichita, KS (US)

(21) Appl. No.: 18/925,635

(22) Filed: Oct. 24, 2024

Related U.S. Application Data
(60) Provisional application No. 63/598,198, filed on Nov. 13, 2023.

(51) Int. Cl. F16M 13/02; B64D 11/00

(52) U.S. Cl. CPC F16M 13/022; B64D 11/00; B64D 2011/0038

(57) ABSTRACT

A removable bracket configured to install to a structure. The removable bracket includes a main bracket body and a mounting clip attached to the main bracket body. The mounting clip includes a pair of prongs configured to insert into a pair of holes in the structure and become secured to the structure.

### CROSS-REFERENCE TO RELATED APPLICATIONS

This application claims the benefit of U.S. Provisional Patent Application No. 63/598,198, filed Nov. 13, 2023, the entire contents thereof are herein incorporated by reference.

### BACKGROUND

### 1. Field

Embodiments disclosed herein relate generally to the field of interior installations. More specifically, the disclosed embodiments relate to the field of toolless mounting brackets.

### 2. Related Art

It is known for brackets to mount to interior panels or structure of an aircraft.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

In some embodiments, the techniques described herein relate to a removable bracket, the removable bracket including: a bracket main body formed from a single piece of material, wherein the bracket main body includes a first portion and a second portion with a first bend between the first and second portions, and a third portion with a second bend between the second and third portions; a mounting clip mechanically coupled to the third portion, wherein the mounting clip is configured to mount the bracket main body to a structure by hand; and a pair of prongs extending from the mounting clip, wherein each of the pair of prongs is configured to insert into a respective one of a pair of holes in the structure.

In some embodiments, the techniques described herein relate to a removable bracket including a mounting hole through the bracket main body wherein the mounting hole is positioned in the second portion.

In some embodiments, the techniques described herein relate to a removable bracket wherein the mounting hole is configured to receive a band which passes through the second portion and wraps around an underside surface of the first portion.

In some embodiments, the techniques described herein relate to a removable bracket including a pad disposed on a rear portion of the mounting clip, wherein the pad is configured to provide cushioning between the mounting clip and the structure.

In some embodiments, the techniques described herein relate to a removable bracket wherein the pair of prongs each include a tabbed end which extends from a respective one of the prongs and are each configured to be received by one of the pair of holes in the structure.

In some embodiments, the techniques described herein relate to a removable bracket wherein the tabbed ends extend from the pair of prongs at a third bend, and the third bend has an angle between ninety degrees and one-hundred eighty degrees.

In some embodiments, the techniques described herein relate to a removable bracket wherein the first bend has an angle between ninety degrees and one-hundred eighty degrees and the second bend has an angle less than ninety degrees.

In some embodiments, the techniques described herein relate to a removable bracket wherein the structure is a lighting rail with holes.

In some embodiments, the techniques described herein relate to a removable bracket wherein when inserted through holes of the lighting rail, the tabbed ends contact an inner edge of the lighting rail, and the pad contacts a lower edge of the lighting rail.

In some embodiments, the techniques described herein relate to a removable bracket wherein a clip is adhered to the first portion and is configured for hanging an item beneath the removable bracket.

In some embodiments, the techniques described herein relate to a removable bracket, the removable bracket including: a bracket main body configured to support an item when the removable bracket is mounted to a structure; a mounting clip attached to the bracket main body, wherein the mounting clip includes: a pair of prongs configured to insert into a pair of holes in the structure for mounting the bracket main body to the structure; a pair of tabbed ends extending from an end of each of the prongs, wherein the tabbed ends are bent away from the prongs such that when inserted into the holes in the structure, the tabbed ends contact an inner edge of the structure thereby preventing the prongs from sliding out of the holes.

In some embodiments, the techniques described herein relate to a removable bracket wherein the bracket main body includes a first portion and a second portion with a first bend between the first and second portions, and a third portion with a second bend between the second and third portions.

In some embodiments, the techniques described herein relate to a removable bracket wherein a pad is attached to the mounting clip and provides cushioning when the mounting clip is mounted to the structure.

In some embodiments, the techniques described herein relate to a removable bracket wherein when the tabbed ends are installed into holes of the structure, the bracket main body is rotated upwards and oriented to allow the tabbed ends to insert into the holes and once the tabbed ends are inserted, the bracket main body rotates downward, and the pad contacts a lower edge of the structure.

In some embodiments, the techniques described herein relate to a removable bracket wherein each of the tabbed ends include a rounded end configured to slide through the holes of the structure.

In some embodiments, the techniques described herein relate to a removable bracket wherein the second portion includes a centered mounting hole configured to allow a banded fastener to pass through the second portion and wrap around the first portion.

In some embodiments, the techniques described herein relate to a removable bracket wherein when the removable bracket is mounted to the structure, the first bend aligns the first portion substantially horizontally and the second portion is angled upwardly from the first bend to the structure.

In some embodiments, the techniques described herein relate to a removable bracket wherein when the structure is disposed beneath an interior ceiling panel and the item is a duct, the duct is secured to the first and second portion of the bracket main body such that the duct is wedged against the interior ceiling panel.

In some embodiments, the techniques described herein relate to a removable bracket wherein the bracket main body is formed from a single piece of material.

In some embodiments, the techniques described herein relate to a removable bracket wherein the mounting clip is formed from a single piece of material.

### BRIEF DESCRIPTION OF THE DRAWING FIGURES

Embodiments of the invention are described in detail below with reference to the attached drawing figures, wherein:

FIG. 1A shows a perspective view of the removable bracket;

FIG. 1B shows another perspective view of the removable bracket;

FIG. 2 shows a perspective view of the mounting clip of the removable bracket of FIG. 1A and FIG. 1B;

FIG. 3 shows a close-up perspective view of the removable bracket installed onto a lighting rail of an aircraft;

FIG. 4 shows another close-up perspective view of the removable bracket installed onto the lighting rail of an aircraft;

FIG. 5 shows a perspective view of two removable brackets installed onto the lighting rail of an aircraft;

FIG. 6 shows a perspective view of three removable brackets supporting a duct; and

FIG. 7 shows a perspective view of two removable brackets with a spring clip.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense. The scope of the invention is defined only by the appended claims, along with the full scope of the equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the technology can include a variety of combinations and/or integrations of the embodiments described herein.

Brackets attached to an aircraft are typically installed with rivets making them a permanent fixture onboard the aircraft and permanently alter aircraft structure.

Embodiments of the present disclosure provide a removable bracket which may hook onto a structural member, such as a stringer, girder, or lighting rail, and insert partially into holes of the structural member. The removable bracket lacks any sort of fastener for holding the bracket on the structure and is designed to be quickly and easily installed by hand, providing a bracket for internally mounting a duct or other non-structural elements to a structure such as an airframe without the need for expensive tooling, coordinated pilot holes, or hard mounting via rivets. The removable bracket, when installed on an aircraft, allows for an aircraft to have different uses and may be removed and installed without impacting or altering the permanent aircraft structure. The removable bracket may be mounted to a structure, such as a lighting rail, in the cabin of an aircraft without any tools.

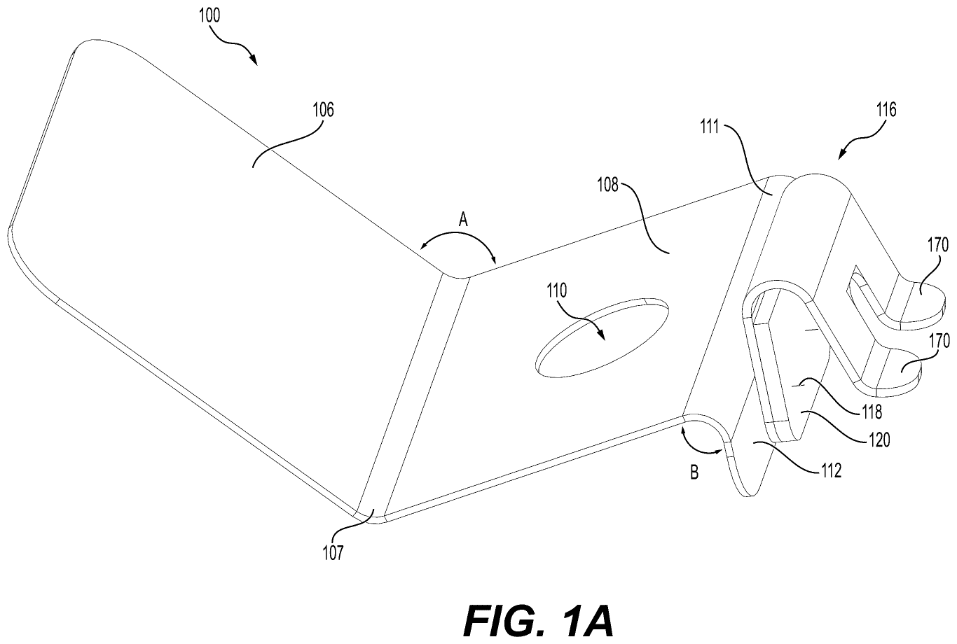

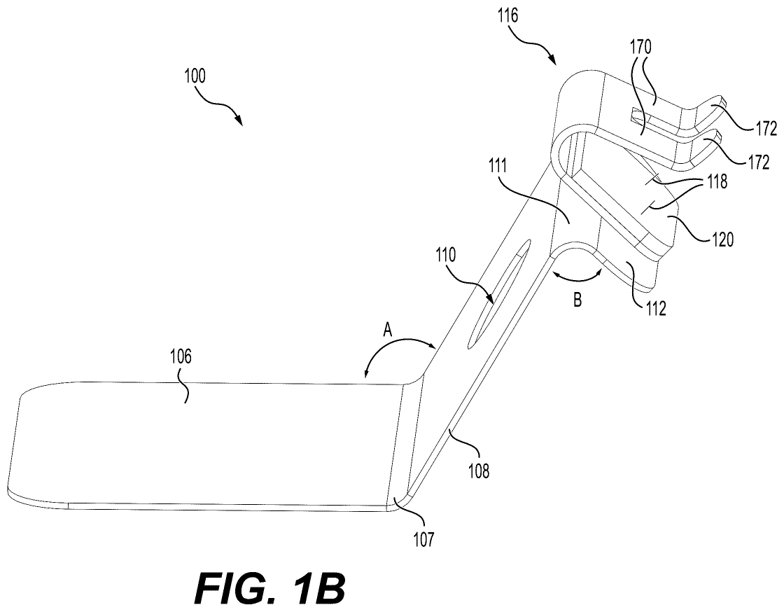

FIG. 1A shows a perspective view of the removable bracket 100. FIG. 1B shows another perspective view of the removable bracket 100. FIGS. 1A and 1B are best viewed together with the following description. The removable bracket 100 comprises a main body which in embodiments is a formed, rigid plate that is substantially rectangular. In embodiments, the body of the removable bracket 100 includes a first bend 107 between a first portion 106 and a second portion 108, and a second bend 111 between the second portion and a third portion 112. The first bend 107 forms an angle A between the first portion 106 and the second portion 108. In embodiments, the angle A is greater than ninety degrees and may be approximately one hundred and twenty degrees. The second bend 111 forms an angle B between the second portion 108 and the third portion 112. In embodiments, the second bend 111 is less than ninety degrees and may be approximately seventy-six degrees. In some embodiments, the angle B may be adjusted based upon the angle of the aircraft structure or upon the intended usage of the removable bracket 100. In some embodiments, the angle B may be adjusted if the length of the first portion 106, second portion 108, or third portion 112 is altered. In embodiments, the second portion 108 includes a mounting hole 110.

The third portion 112 forms a flange. A mounting clip 116 is attached to an upwardly facing surface of the third portion 112. For example, the mounting clip 116 may be mechanically coupled and fastened to the third portion 112 using fasteners 118. In embodiments, the fasteners 118 are rivets. A pad 120 may optionally be fastened to mounting clip 116 using an adhesive bond. A distal end of the mounting clip 116 comprises a pair of prongs 170.

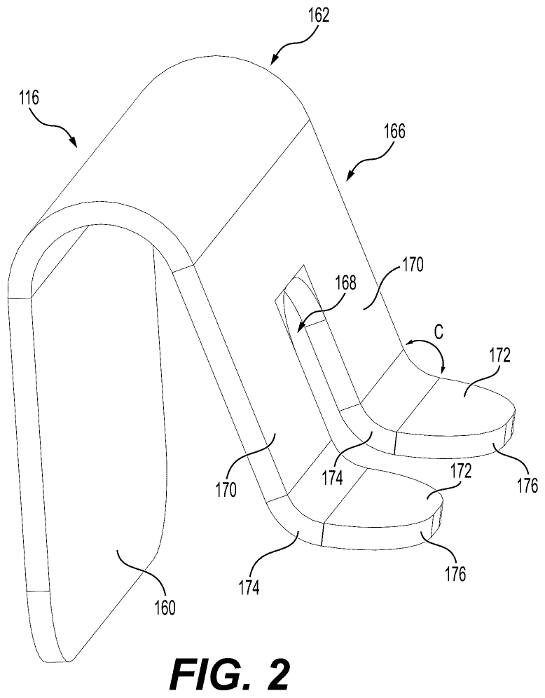

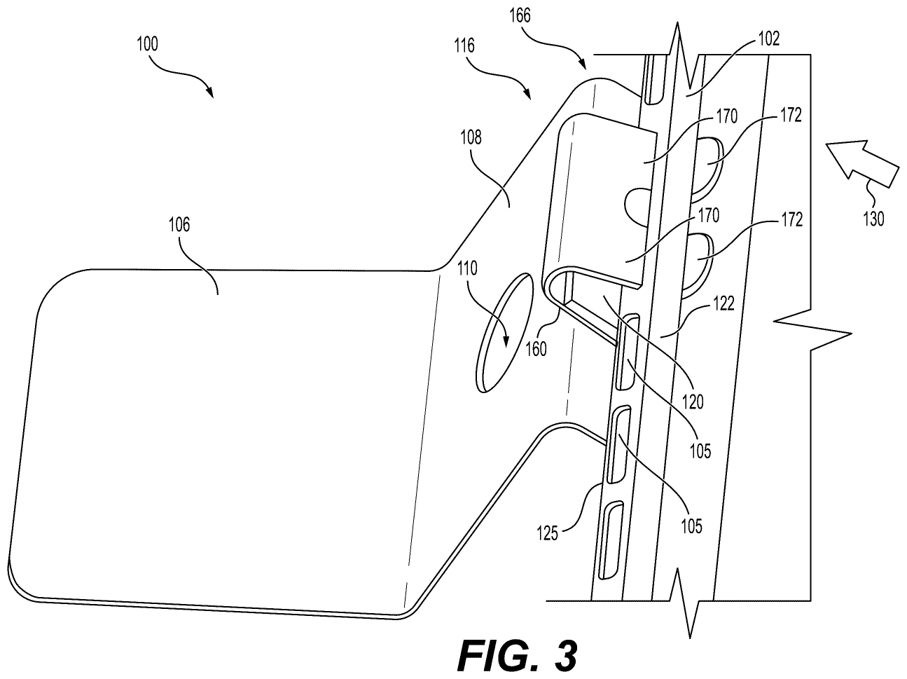

FIG. 2 shows a perspective view of the mounting clip 116. In embodiments, the mounting clip 116 is formed from a single piece of material and includes a flat portion 160, a curved portion 162, and a pronged portion 166. The pronged portion 166 includes a pair of prongs 170 which are substantially identical in size, shape, and orientation. A gap 168 between the prongs 170 separates and makes each prong distinct from one another. Each prong 170 has a third bend 174 that forms a tabbed end 172 angled relative to the prongs 170 at an angle C. In embodiments, the angle C is greater than ninety degrees and may be approximately one hundred eighteen degrees. The tabbed ends 172 each have a rounded end 176 and are configured for insertion into the holes 105 on the aircraft structure (i.e., lighting rail 102 see FIG. 3).

The pad 120 is mounted to the inner face of the rear portion 160 with the outer face of the rear portion 160 being mounted to the third portion 112 allowing both the pad 120 and the mounting clip 116 to be aligned in a parallel orientation with the third portion 112. With reference to FIG. 3, the pad 120 is positioned on the rear portion 160 such that when the removable bracket 100 is slid onto the lighting rail 102, the exposed outer surface of the pad 120 contacts the surface of the lighting rail 102. In embodiments, the pad 120 is substantially rectangular and may be fabricated from rubber or another suitable cushioning material to substantially prevent damage on the removable bracket 100 or the lighting rail 102.

FIG. 3 shows a perspective view of the removable bracket 100 installed onto a structure. In embodiments, the removable bracket 100 is installed onto a lighting rail 102 of an aircraft, however, in other embodiments removable bracket 100 may be installed onto different structures, or aircraft structures such as girders, panels, or rails. The tabbed ends 172 of the pronged portion 166 on the mounting clip 116 are each slid into a hole 105 on the lighting rail 102. The rounded ends 176 are shaped to assist with insertion of the tabbed ends 172 into a hole 105 on lighting rail 102. The lateral extension of the tabbed ends 172 away from the pronged portion 166 allows for the tabbed ends 172 to slide into holes 105 and engage with the lighting rail 102 such that when fully inserted into a hole 105, each tabbed end 172 abuts an inner edge 122 of the lighting rail 102. In embodiments, to install the removable bracket 100 onto the lighting rail 102, the removable bracket 100 is pivoted or rotated upwards and oriented to allow the tabbed ends 172 to insert into the holes 105 on the lighting rail 102. Once the tabbed ends 172 are inserted, the removable bracket 100 falls into place from the downward force of gravity and the pad 120 adhered to the third portion 112 contacts a lower edge 125 of the lighting rail 102. To remove the removable bracket 100, the mounting clip 116 is raised upwards and the tabbed ends 172 are slid out from the holes 105. Since the tabbed ends 172 are able to only be slid out from the holes 105 when the removable bracket 100 is raised, the removable bracket 100 is substantially prevented from becoming removed from the lighting rail 102 when a load, such as a duct, is applied onto the removable bracket 100 and thus applies a downward force.

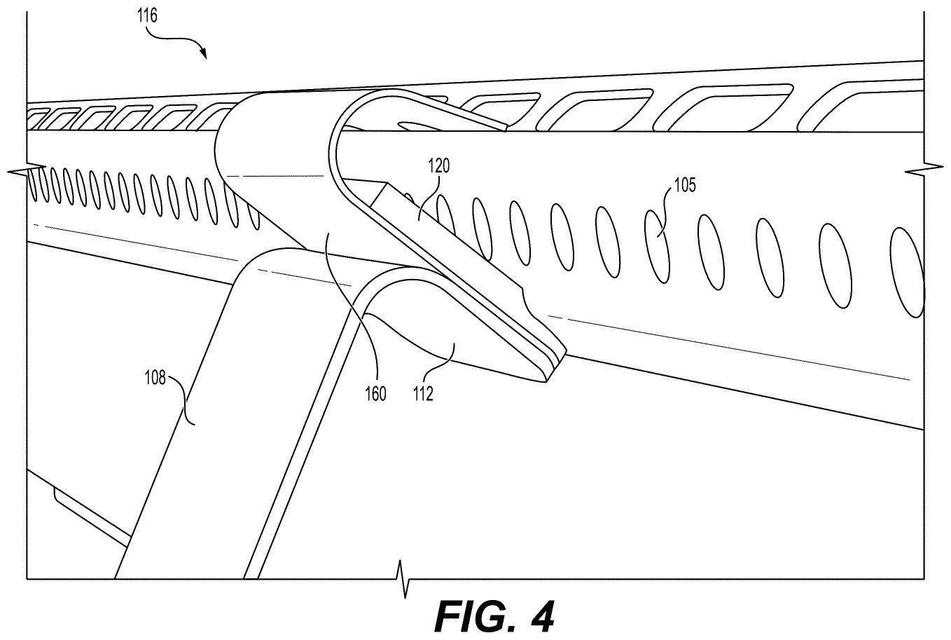

FIG. 4 shows another perspective view of the removable bracket 100 installed onto the lighting rail 102 of the aircraft. The mounting clip 116 is mounted to the third portion 112 and the pad 120 is configured on the inner face of the rear portion 160 of the mounting clip 116. When the removable bracket 100 is mounted onto the lighting rail 102 the pad 120 provides cushioning between the rear portion 160 and the lighting rail 102 to provide cushion between the surface of the mounting clip 116 and the surface of the lighting rail 102.

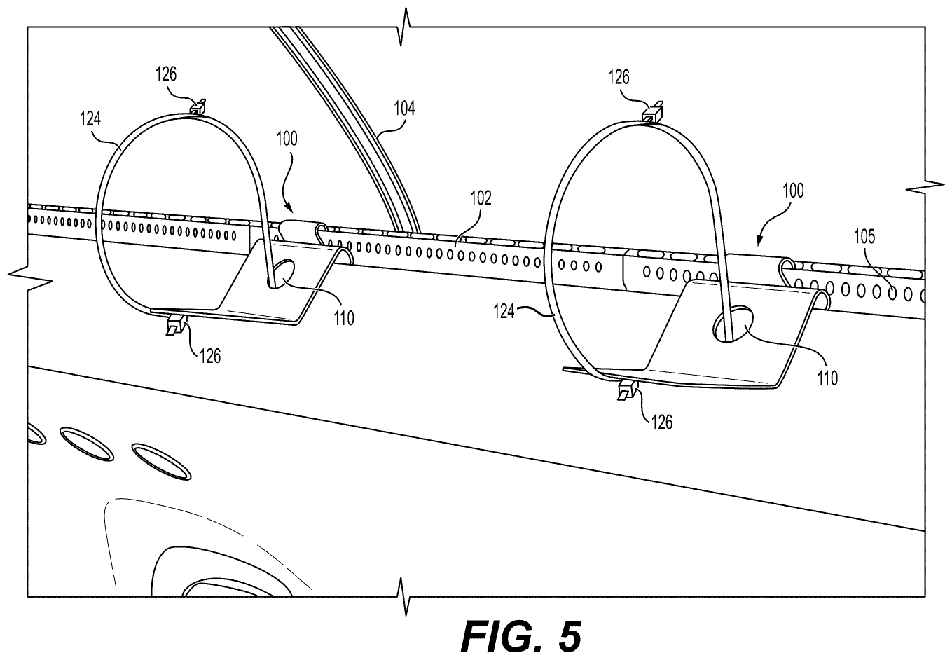

FIG. 5 shows a perspective view of the removable bracket 100 installed onto the lighting rail 102 of an aircraft. The view in FIG. 5 shows two removable brackets 100. The removable bracket 100 is mounted to a lighting rail 102 positioned along an upper portion of the aircraft fuselage and substantially aligned along a lower portion of an interior ceiling panel 104 within the cabin of an aircraft. The lighting rail 102 includes a plurality of holes 105 spanning along the length of the lighting rail 102. The mounting hole 110 of the second portion 108 allows for a cord or band 124 to pass through the mounting hole 110 and wrap around to the underneath surface of the first portion 106. The band 124 includes fasteners 126. The fasteners 126 allow for the length of the band 124 to be altered such that a desired length may be achieved. In embodiments, the fasteners may be a zip tie or a similar type of fastening element.

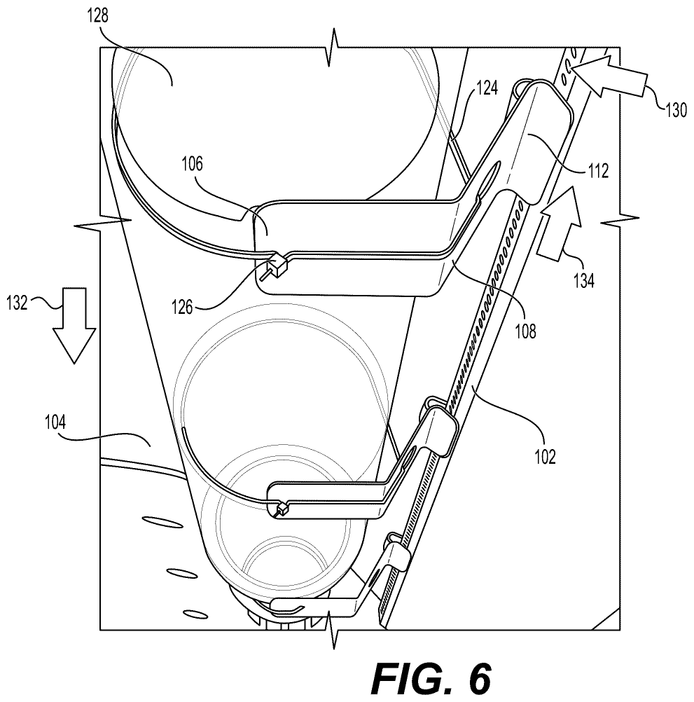

FIG. 6 shows a perspective view of the removable bracket 100 supporting and securing a duct 128 in an embodiment. The duct 128 is depicted to be see-through in FIG. 6 to reveal the band 124 stretching around the duct 128. The duct 128 may substantially rest on the first portion 106 and second portion 108 of the removable bracket 100 due to first bend 107 and angle A between the first portion 106 and second portion 108 which allow first portion 106 to be substantially horizontal underneath duct 128. The removable bracket 100 is mounted to the lighting rail 102 using the tabbed ends 172 (FIG. 3) which insert into the holes 105. With reference to FIG. 3, the tabbed ends 172 are inserted through the holes 105 with the angle (angle C) of the tabbed ends 172 allowing the upper surface of each tabbed end 172 to contact the inner edge 122 of the lighting rail 102. The downward force of gravity on the first portion 106 and second portion 108 (and possibly a load such as a duct) creates a first force 132 which is a downward force on the first portion 106 with reference to FIG. 6. The geometrical configuration of the removable bracket 100 allows for reaction forces created by the downward force of gravity (i.e., first force 132) to substantially lock into place the removable bracket 100. The first force 132 (i.e., the gravitational force) applied on the first portion 106 creates a reaction force, a second force 134, which is angled upwards and applied onto the third portion 112. The second force 134 pushes the third portion 112 against the lighting rail 102 (the pad 120 preventing direct contact between the surface of the third portion 112 and the lighting rail 102). Additionally, another reaction force, a third force 130 (FIG. 3) is applied to the tabbed ends 172 inserted through the holes 105 of the lighting rail 102. The third force 130 is applied horizontally and slightly upwardly and pushes the tabbed ends 172 towards the inner edge 122 of the lighting rail 102. The gravitational force (i.e., the first force 132) when increased, increases the reaction forces (i.e., the second force 134 and the third force 130) causing the removable bracket 100 to substantially lock into place when a duct 128 or some other force creating element increases the gravitational force (the first force 132) applied to the first portion 106. The geometric configuration including the first bend 107, second bend 111, and the third bend 174 of the removable bracket 100 substantially allows the removable bracket 100 to be secured when force loads are applied. The duct 128 in embodiments may be pressed against the interior ceiling panel 104 creating a wedging effect between the removable bracket 100 and the interior ceiling panel 104 substantially preventing disengagement of the removable bracket 100 from the lighting rail 102.

Returning to FIG. 6 the band 124 passes along the underside surface of the first portion 106 and second portion 108 and passes through the mounting hole 110 to wrap around the duct 128. The fasteners 126 are configured on the band 124 such that, when tightened, the available length of the band 124 may be decreased so that the duct 128 may be secured to the removable bracket 100. The adjustable configuration of the band 124 may allow for ducts of different sizes to be secured onto the removable bracket 100. In embodiments, a duct having a diameter of approximately five inches is shown but in other embodiments many different sizes of ducts may be secured. In some embodiments, the duct 128 may have increased securement and stabilization when the duct 128 contacts the ceiling panel 104 while being secured to the removable bracket 100. FIG. 6 shows three removable brackets 100 spaced apart and being fastened to the duct 128. In other embodiments, any number of removable brackets 100 may be used to secure a duct similar to duct 128.

The removable bracket 100 may easily and quickly be installed and removed from the lighting rail 102 within the aircraft cabin. The installation and removal of the removable bracket 100 to the lighting rail 102 may be done by hand without any hardware (i.e., bolts or screws) or tools.

In some embodiments, the removable bracket 100 may be used to secure items other than ducts. Other items the removable bracket 100 may be used to secure include, but are not limited to, intravenous (IV) bags or lighting. An IV bag may be secured using the mounting hole 110 and securing the bag to the band 124 passing through mounting hole 110. When being used to support an IV bag the removable bracket 100 may include a mechanical device such as a spring clip to prevent the removable bracket 100 from being raised and disengaging from the lighting rail 102. Numerous other interior aircraft components may be secured using one or many of the removable brackets 100.

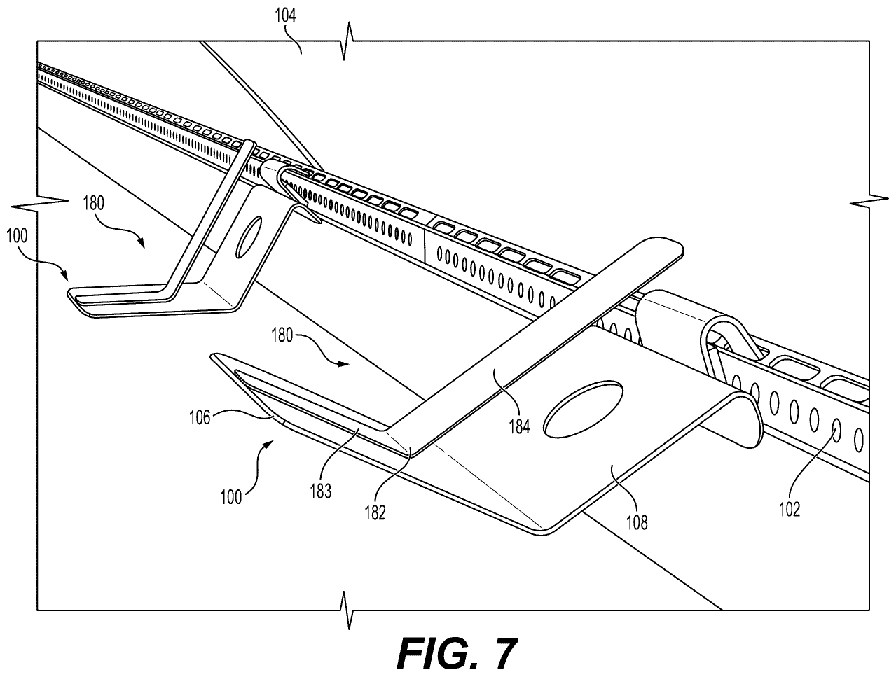

FIG. 7 shows a perspective view of two removable brackets 100 with a clip 180. The clip 180 may be used when the removable bracket 100 is used to secure an item that hangs below bracket 100, such as an IV bag. In embodiments, clip 180 is a spring clip configured for flexing to enable installing and uninstalling of bracket 100 as further described below. A first bend 182 of the clip 180 is created from a first portion 183 and a second portion 184. The first portion 183 is adhered to the first portion 106 of the removable bracket 100 with the second portion 184 of the clip 180 extending at an angle away from first portion 183. The second portion 184 of the clip 180 has a greater length than the second portion 108 of the removable bracket 100 such that when the removable bracket 100 is installed onto the lighting rail 102 the second portion 184 of the clip 180 contacts the interior ceiling panel 104 when the removable bracket 100 is rotated upwards.

FIG. 7 shows a rear removable bracket 100 attached to the lighting rail 102 with a forward removable bracket 100 attached to the lighting rail 102 and being rotated such that the second portion 184 of the clip 180 contacts the interior ceiling panel 104. The contact between the second portion 184 of the clip 180 and the interior ceiling panel 104 substantially prevents the removable bracket 100 from rotating to the point where it may detach from the lighting rail 102. The removable bracket 100 may be removed by flexing the second portion 184 of the clip 180 towards the lighting rail 102 which allows the tabbed ends 172 of the removable bracket 100 to disengage with the lighting rail 102.

In other embodiments the removable bracket 100 may be used to support working lights during aircraft maintenance operations in which case no mechanical device would be required to prevent disengagement of the removable bracket 100 from the lighting rail 102.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

What is claimed is:

1. A removable bracket, the removable bracket comprising:
a bracket main body formed from a single piece of material, wherein the bracket main body comprises a first portion and a second portion with a first bend between the first and second portions, and a third portion with a second bend between the second and third portions;
a mounting clip mechanically coupled to the third portion, wherein the mounting clip is configured to mount the bracket main body to a structure by hand; and
a pair of prongs extending from the mounting clip, wherein each of the pair of prongs is configured to insert into a respective one of a pair of holes in the structure.

2. The removable bracket of claim 1, comprising a mounting hole through the bracket main body wherein the mounting hole is positioned in the second portion.

3. The removable bracket of claim 2, wherein the mounting hole is configured to receive a band which passes through the second portion and wraps around an underside surface of the first portion.

4. The removable bracket of claim 1, comprising a pad disposed on a rear portion of the mounting clip, wherein the pad is configured to provide cushioning between the mounting clip and the structure.

5. The removable bracket of claim 1, wherein the pair of prongs each include a tabbed end which extends from a respective one of the prongs and are each configured to be received by one of the pair of holes in the structure.

6. The removable bracket of claim 5, wherein the tabbed ends extend from the pair of prongs at a third bend, and the third bend has an angle between ninety degrees and one-hundred eighty degrees.

7. The removable bracket of claim 1, wherein the first bend has an angle between ninety degrees and one-hundred eighty degrees and the second bend has an angle less than ninety degrees.

8. The removable bracket of claim 1, wherein the structure is a lighting rail with holes.

9. The removable bracket of claim 8, wherein when inserted through holes of the lighting rail, the tabbed ends contact an inner edge of the lighting rail and the pad contacts a lower edge of the lighting rail.

10. The removable bracket of claim 1, wherein a clip is adhered to the first portion and is configured for hanging an item beneath the removable bracket.

11. A removable bracket, the removable bracket comprising:
a bracket main body configured to support an item when the removable bracket is mounted to a structure;
a mounting clip attached to the bracket main body, wherein the mounting clip comprises:
a pair of prongs configured to insert into a pair of holes in the structure for mounting the bracket main body to the structure;
a pair of tabbed ends extending from an end of each of the prongs, wherein the tabbed ends are bent away from the prongs such that when inserted into the holes in the structure, the tabbed ends contact an inner edge of the structure thereby preventing the prongs from sliding out of the holes.

12. The removable bracket of claim 11, wherein the bracket main body includes a first portion and a second portion with a first bend between the first and second portions, and a third portion with a second bend between the second and third portions.

13. The removable bracket of claim 11, wherein a pad is attached to the mounting clip and provides cushioning when the mounting clip is mounted to the structure.

14. The removable bracket of claim 13, wherein when the tabbed ends are installed into holes of the structure, the bracket main body is rotated upwards and oriented to allow the tabbed ends to insert into the holes and once the tabbed ends are inserted, the bracket main body rotates downward and the pad contacts a lower edge of the structure.

15. The removable bracket of claim 11, wherein each of the tabbed ends include a rounded end configured to slide through the holes of the structure.

16. The removable bracket of claim 12, wherein the second portion includes a centered mounting hole configured to allow a banded fastener to pass through the second portion and wrap around the first portion.

17. The removable bracket of claim 12, wherein when the removable bracket is mounted to the structure, the first bend aligns the first portion substantially horizontally and the second portion is angled upwardly from the first bend to the structure.

18. The removable bracket of claim 17, wherein when the structure is disposed beneath an interior ceiling panel and the item is a duct, the duct is secured to the first and second portion of the bracket main body such that the duct is wedged against the interior ceiling panel.

19. The removable bracket of claim 12, wherein the bracket main body is formed from a single piece of material.

20. The removable bracket of claim 12, wherein the mounting clip is formed from a single piece of material.
